(19) United States
(12) Patent Application Publication
(10) Pub. No.: US 2018/0048929 A1
(43) Pub. Date: Feb. 15, 2018

(54) METHOD AND APPARATUS FOR DISPLAYING INFORMATION-PRESENTATION-ITEM, AND MULTIMEDIA PLAYBACK DEVICE

(71) Applicant: TENCENT TECHNOLOGY (SHENZHEN) COMPANY LIMITED, Shenzhen (CN)

(72) Inventors: Gang XU, Shenzhen (CN); Ming LUO, Shenzhen (CN); Ping WANG, Shenzhen (CN); Xiaomin YAN, Shenzhen (CN); Dan YANG, Shenzhen (CN); Yi XIE, Shenzhen (CN)

(21) Appl. No.: 15/794,356

(22) Filed: Oct. 26, 2017

Related U.S. Application Data
(63) Continuation of application No. PCT/CN2016/092731, filed on Aug. 1, 2016.

(30) Foreign Application Priority Data
Aug. 31, 2015 (CN) 201510549403.6

(51) Int. Cl. H04N 21/431; H04N 21/858; G06F 17/30

(52) U.S. Cl. CPC H04N 21/431; G06F 17/30725; G06F 17/30997; H04N 21/858; H04M 1/72522

(57) ABSTRACT

The present disclosure provides an information-presentation-item display method for a multimedia playback device connected to a server. The method includes: playing a first content; playing an information-presentation-item, different from the first content, provided by the server; receiving a confirmation instruction sent by a remote-control device bound to the multimedia playback device; displaying, according to the confirmation instruction, description information related to the information-presentation-item, the description information including a display graphic code; and displaying first extension information related to the information-presentation-item after it is confirmed that the graphic code is scanned based on a graphic code link corresponding to the graphic code received by the server, the first extension information being information for extending content in the description information.

### RELATED APPLICATIONS

This application is a continuation application of PCT Patent Application No. PCT/CN2016/092731, filed on Aug. 1, 2016, which claims priority to Chinese Patent Application No. 201510549403.6, entitled “METHOD AND APPARATUS FOR DISPLAYING INFORMATION-PRESENTATION-ITEM, AND MULTIMEDIA PLAYBACK DEVICE” filed on Aug. 31, 2015, which is incorporated by reference in its entirety.

### FIELD OF THE TECHNOLOGY

Embodiments of the present invention relate to the multimedia playback technology field and, in particular, to a method and apparatus for displaying information-presentation-items, and a multimedia playback device thereof.

### BACKGROUND OF THE DISCLOSURE

An information-presentation-item is a content window played by a multimedia playback device while playing a video content, and the information-presentation-item may be related or unrelated to the video content, such as advertisement or notification. With the popularity of the Internet, applications of the information-presentation-item become increasingly widespread, and more and more information-presentation-items begin to be used in video-in-demand using a set top box or a smart TV.

To play an information-presentation-item, a client side may first play the information-presentation-item before playing a video, or play the information-presentation-item during the playback of the video. When the information-presentation-item is played, a countdown can be started and, at the end of the countdown, playing the information-presentation-item is stopped and the playback of the video is continued.

According to the present disclosure, the above information-presentation-item playing method has at least the following problems: during the playing process, the information-presentation-item is just played passively, and the information obtained by a user from the information-presentation-item is rather limited, making it less effective to push the information-presentation-item.

### SUMMARY

To resolve the above problems, embodiments of the present invention provide a method and apparatus for displaying an information-presentation-item, and a multimedia playback device thereof. The technical solutions include followings.

One aspect of the present disclosure provides an information-presentation-item display method. The method is applied to and implemented by a multimedia playback device connected to a server, and the method includes: playing a first content; playing an information-presentation-item, different from the first content, provided by the server; receiving a confirmation instruction sent by a remote-control device bound to the multimedia playback device; displaying, according to the confirmation instruction, description information related to the information-presentation-item, the description information including a display graphic code; and displaying first extension information related to the information-presentation-item after it is confirmed that the graphic code is scanned based on a graphic code link corresponding to the graphic code received by the server, the first extension information being information for extending content in the description information.

Another aspect of the present disclosure provides a non-transitory computer-readable storage medium containing computer-executable instructions for, when executed by one or more processors, performing an information-presentation-item display method for a multimedia playback device connected to a server. The method includes: playing a first content; playing an information-presentation-item, different from the first content, provided by the server; receiving a confirmation instruction sent by a remote-control device bound to the multimedia playback device; displaying, according to the confirmation instruction, description information related to the information-presentation-item, the description information including a display graphic code; and displaying first extension information related to the information-presentation-item after it is confirmed that the graphic code is scanned based on a graphic code link corresponding to the graphic code received by the server, the first extension information being information for extending content in the description information.

Another aspect of the present disclosure provides a multimedia playback device. The multimedia playback device includes a memory storing one or more programs; and one or more processors coupled to the memory. The processors are, when executing the one or more programs, configured for: playing a first content; playing an information-presentation-item, different from the first content, provided by the server; receiving a confirmation instruction sent by a remote-control device bound to the multimedia playback device; displaying, according to the confirmation instruction, description information related to the information-presentation-item, the description information including a display graphic code; and displaying first extension information related to the information-presentation-item after it is confirmed that the graphic code is scanned based on a graphic code link corresponding to the graphic code received by the server, the first extension information being information for extending content in the description information.

### BRIEF DESCRIPTION OF THE DRAWINGS

To describe the technical solutions of the embodiments of the present invention more clearly, the following briefly introduces the accompanying drawings. Apparently, the accompanying drawings in the following description show only some embodiments of the present invention, and a person skilled in the art may derive other drawings from these accompanying drawings without creative efforts.

FIG. 1 is a schematic diagram of an implementation environment involved in an information-presentation-item display method according to some embodiments of the present invention;

FIG. 2 is a flowchart of an information-presentation-item display method according to an embodiment of the present invention;

FIG. 3A is a flowchart of an information-presentation-item display method according to another embodiment of the present invention;

FIG. 3B is a schematic diagram of an information-presentation-item that displays guidance information according to an embodiment of the present invention;

FIG. 3C is a schematic diagram of an overlay-floating-window that displays description information according to an embodiment of the present invention;

FIG. 3D is a schematic diagram of replacing description information with first extension information for displaying in an overlay-floating-window according to an embodiment of the present invention;

FIG. 4 is a flowchart of an information-presentation-item display method according to still another embodiment of the present invention;

FIG. 5 is a flowchart of an information-presentation-item display method according to still yet another embodiment of the present invention;

FIG. 6A is a diagram of an information flow in a rich media framework according to an embodiment of the present invention;

FIG. 6B is a schematic diagram of a rich media framework according to an embodiment of the present invention;

FIG. 7 is a schematic structural diagram of an apparatus for displaying an information-presentation-item according to an embodiment of the present invention;

FIG. 8 is a schematic structural diagram of an apparatus for displaying an information-presentation-item according to another embodiment of the present invention; and

FIG. 9 is a schematic structural diagram of a multimedia playback device according to an embodiment of the present invention.

### DESCRIPTION OF EMBODIMENTS

To make the technical solutions, and advantages of the present disclosure clearer, the following further describes implementations of the present disclosure in detail with reference to the accompanying drawings.

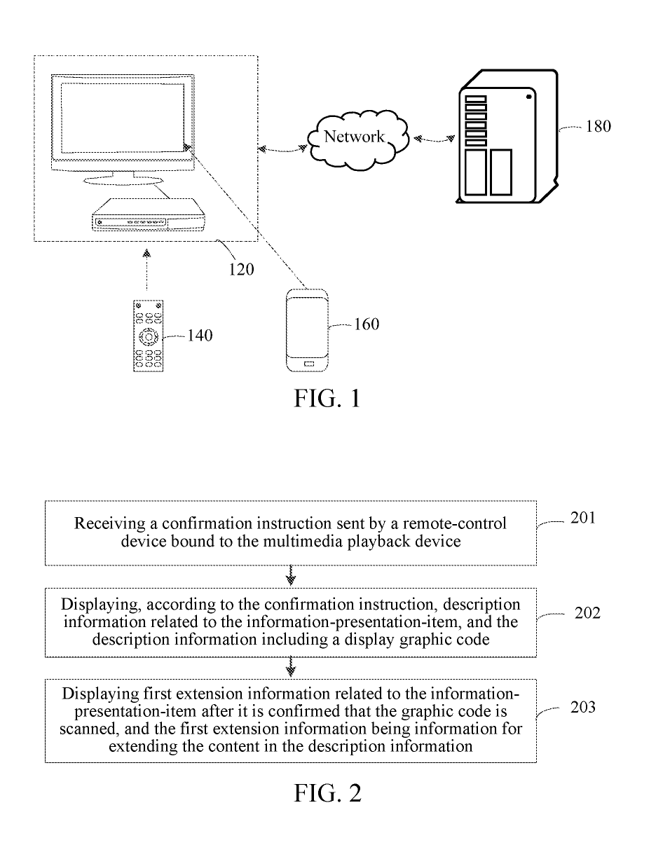

FIG. 1 is a schematic diagram of an implementation environment involved in an information-presentation-item display method according to some embodiments of the present invention. The implementation environment may include a multimedia playback device 120, a remote-control device 140 matching the multimedia playback device 120, a mobile device 160, and a server 180, etc.

The multimedia playback device 120 may be a smart TV. The remote-control device 140 is bound to or matches the multimedia playback device 120. When a key on the remote-control device 140 is pressed, the remote-control device 140 sends an instruction generated after pressing the key to the multimedia playback device 120.

The instruction generated by remote-control device 140 may be transmitted between the remote-control device 140 and the multimedia playback device 120 in a wireless manner. Generally, the remote-control device 140 transmits a signal to the multimedia playback device 120 by using an infrared ray or in another manner. The signal transmitted by the remote-control device 140 to the multimedia playback device 120 is usually encoded in a preset encoding manner. The multimedia playback device 120 may decode a received signal in a decoding manne+569874, or another device having a scanning function of a camera.

The server 180 provides an information-presentation-item for the multimedia playback device 120. The server 180 may be connected to the multimedia playback device 120 and the mobile device 160 by using a wired network or a wireless network.

Referring to FIG. 2, FIG. 2 is a flowchart of an information-presentation-item display method according to an embodiment of the present invention. As an example, the information-presentation-item display method is applied to the multimedia playback device 120 in the implementation environment shown in FIG. 1. The information-presentation-item display method may include the followings.

Step 201: Receiving a confirmation instruction sent by a remote-control device bound to the multimedia playback device. In some embodiments, the confirmation instruction may be received when an information presentation item is currently being played.

Step 202: Displaying, according to the confirmation instruction, description information related to the information-presentation-item, and the description information including a display graphic code.

Step 203: Displaying first extension information related to the information-presentation-item after it is confirmed that the graphic code is scanned, and the first extension information being information for extending the content in the description information.

Thus, according to the information-presentation-item display method provided in this embodiment of the present invention, during playing of an information-presentation-item (i.e., when the information-presentation-item is currently being played), description information related to the information-presentation-item is displayed under the control of a remote-control device, and a user may scan a graphic code according to the description information to obtain more information. Because, during playing of the information-presentation-item, the user can determine whether or not to be involved in playing of the information-presentation-item or to scan the graphic code, those problems in related technologies can be resolved: during the playing process, the information-presentation-item is just played passively, and the information obtained by a user from the information-presentation-item is rather limited, making it less effective to push the information-presentation-item. In this way, during playing of an information-presentation-item, interaction between a multimedia playback device and a user is enhanced, and the effectiveness of pushing the information-presentation-item is improved.

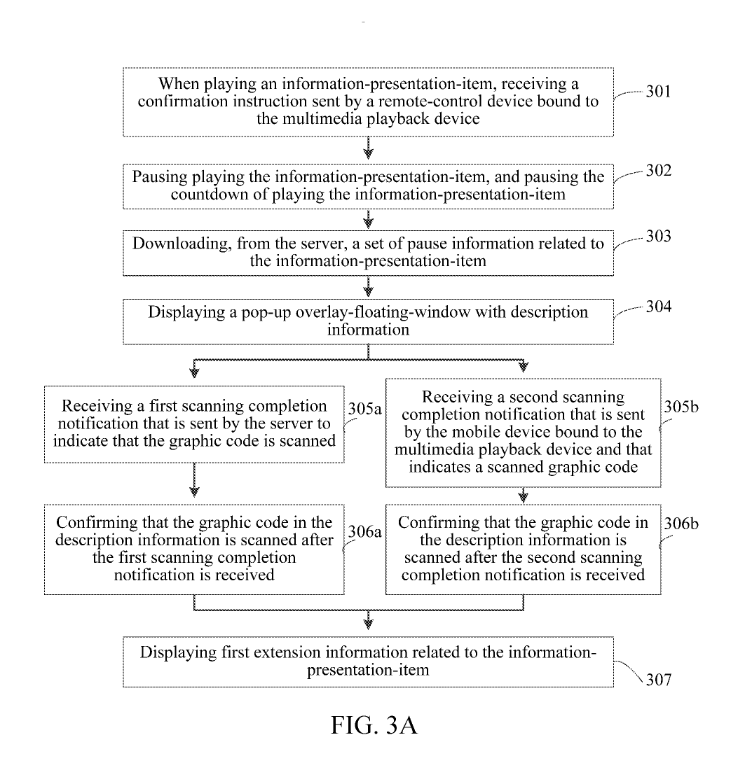

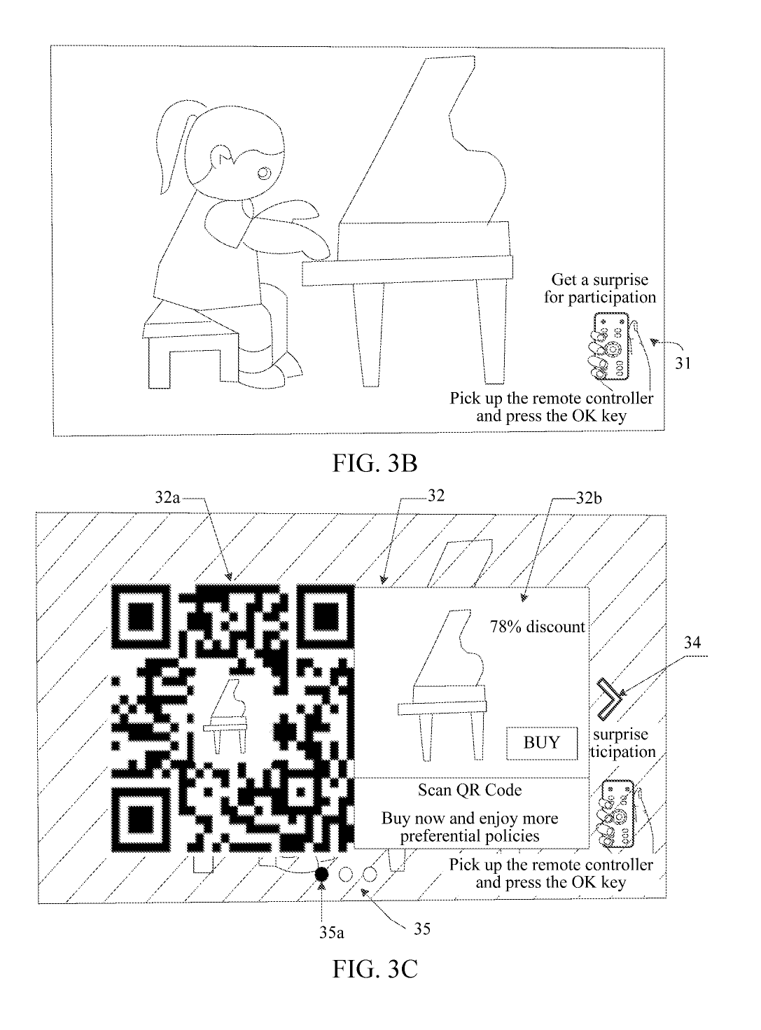

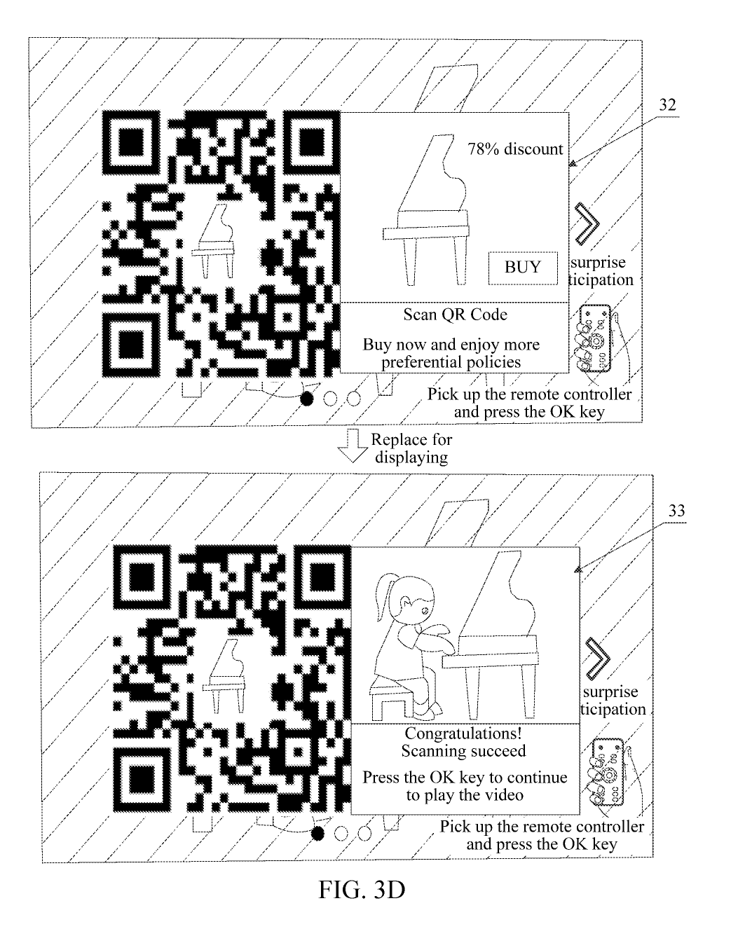

Referring to FIG. 3A, FIG. 3A is a flowchart of an information-presentation-item display method according to another embodiment of the present invention. As an example, the information-presentation-item display method is applied to the multimedia playback device 120 in the implementation environment shown in FIG. 1. The information-presentation-item display method may include the followings.

Step 301: When playing an information-presentation-item, receiving a confirmation instruction sent by a remote-control device bound to the multimedia playback device.

The information-presentation-item described herein refers to a presentation or display item played by the multimedia playback device while playing a network video, for example, an overlay advertisement or a reminder notification. The overlay advertisement described herein is usually advertisement data independent from the video being played. The overlay advertisement may be related or unrelated to content of the video being played. The reminder notification herein may be any appropriate notification message, such as a weather notification, or an earthquake reminder notification sent by a seismological department, or a donation notification sent by a Red Cross sector, without specific limitation.

The multimedia playback device may display or play the information-presentation-item before the network video is played; or may pause the network video when the network video is being played, display or play the information-presentation-item, and continue to play the paused network video after playing of the information-presentation-item is complete; or may display or play the information-presentation-item overlaying the video frames of the network video during playing of the network video. Generally, the information-presentation-item and other network video are sequentially and continuously played on the multimedia playback device, and a same information-presentation-item may be configured to be played sequentially and continuously together with various types of network videos. “Being played sequentially and continuously” may be understood as follows: the information-presentation-item is first played, and after playing of the information-presentation-item is complete, the network video continues to be played; or the network video is first played, and after playing of the network video is complete for a preset time duration, the information-presentation-item continues to be played.

The information-presentation-item may be statically played or displayed or may be dynamically played or displayed. For example, the information-presentation-item may be a presentation item including several video frames, or may be a motion picture. That is, the information-presentation-item may be played in a form of a video, audio, a picture, text, or the like. In certain embodiments, the information-presentation-item is played in a form of a video.

For example, when an advertiser wants to promote an advertisement, the advertiser may negotiate with a server of a network video to send the advertisement to the server. The server may push the advertisement to the multimedia playback as an information-presentation-item. For another example, when a seismological department needs to push an earthquake reminder notification to users, the seismological department may negotiate with a server of a network video to send the earthquake reminder notification to the server. The server may push the earthquake reminder notification to the multimedia playback device as an information-presentation-item.

Specifically, the server may add the information-presentation-item to each of the network videos provided by the server. When the multimedia playback device requests one of the network videos, the information-presentation-item and the network video are sent to the multimedia playback device together. In this case, the multimedia playback device may play the obtained data and, apparently, the information-presentation-item sent together with the network video is to be played at this time.

Further, the server may negotiate with a player application corresponding to the server, so that the player application downloads the information-presentation-item and, during playing of any network video, plays the information-presentation-item at a preset time point while playing of the network video. The preset time point described herein may be a time point before playing of the network video, or a time point during playing of the network video, or a time point after playing of the network video. No specific limitation is intended on the specific representation format of the information-presentation-item or the time of downloading or playing the information-presentation-item.

Generally, the information-presentation-item displays guidance information used for guiding a user to control the remote-control device. For example, the guidance information may be described as having the user to control a key on the remote-control device. Apparently, the multimedia playback device may obtain an instruction, i.e., the confirmation instruction, generated by the remote-control device after the key on the remote-control device is pressed. That is, the confirmation instruction is generated after the user correspondingly controls the remote-control device according to the guidance information. The remote-control device described herein may be a remote-controller configured to remotely control the multimedia playback device.

Referring to FIG. 3B, FIG. 3B is a schematic diagram of an information-presentation-item with guidance information according to an embodiment of the present invention. In FIG. 3B, guidance information 31 is displayed at the bottom right corner of an information-presentation-item being played on the multimedia playback device. The guidance information 31 includes an icon of the remote-control device and a text description “pick up the remote-controller and press the OK key” for guiding a user to press the preset key on the remote-control device.

Apparently, the display position of the guidance information in the information-presentation-item is not limited to the bottom right corner, and may be another preset position, and content of the guidance information is also not limited to the content shown in FIG. 3B.

In addition, the preset key described in the guidance information to guide the user to press on the remote-control device is not limited to the “OK” key on the remote-control device. In an actual application, the multimedia playback device may receive an instruction generated when any key on the remote-control device is pressed. However, only when the instruction received from the remote-control device matches an instruction prestored by the multimedia playback device, it can be determined that the remote-control device receives the confirmation instruction.

The confirmation instruction described herein is sent by the remote-control device to the multimedia playback device by using an infrared ray, and the confirmation instruction can be recognized by the multimedia playback device only when the multimedia playback device and the remote-control device are matching.

Further, after receiving the instruction sent by the remote-control device, the multimedia playback device detects whether the instruction is the same as a prestored instruction and, if the received instruction is the same as the prestored instruction, determines that the confirmation instruction is received. The prestored instruction herein is an instruction that is prestored by the multimedia playback device and that is the same as an instruction generated by the remote-control device in a preset manner.

For example, the preset manner described herein may be that a preset key on the remote-control device is pressed. The preset key may be a key described in the guidance information to guide the user to press on the remote-control device, and may be, for example, an OK key, a menu key, or a return key.

For another example, the preset manner described herein may be that the remote-control device moves along a preset track. The preset track may be a forward track, a backward track, a circular track, or the like.

Step 302: Pausing playing the information-presentation-item, and pausing the countdown of playing the information-presentation-item.

After receiving the confirmation instruction, the multimedia playback device may first pause the playing of information-presentation-item. To reduce impact of the information-presentation-item on the viewing of the network video, the information-presentation-item usually has a preset play-time duration. When the information-presentation-item starts to be played, the multimedia playback device counts down the playing of the information-presentation-item, and when the countdown reaches the preset play-time duration ends, the multimedia playback device stops playing the information-presentation-item. Therefore, when an information-presentation-item has a preset play-time duration, the multimedia playback device further needs to pause the countdown for the information-presentation-item after pausing playing of the information-presentation-item.

Step 303: Downloading, from the server, a set of pause information related to the information-presentation-item.

The pause information includes at least description information and first extension information that are related to the information-presentation-item. The description information includes a display graphic code, and the first extension information includes the description information used for indicating that the graphic code has been successfully scanned.

After receiving the confirmation instruction, the multimedia playback device may download the pause information of the information-presentation-item. Content of pause information of each information-presentation-item is usually related to content of the information-presentation-item. For example, the pause information may be description information used for describing a product involved in the information-presentation-item. The pause information herein may be presented in the form of a picture. Apparently, the pause information may be alternatively presented in the form of text or the like, without specific limitation.

The pause information of each information-presentation-item may include at least description information and first extension information that are related to the information-presentation-item. When the information-presentation-item is related to a product, the description information may further include product information related to the information-presentation-item. The product information may include a picture, price, a sales link, and the like of the product related to the information-presentation-item.

The first extension information further includes extension information for providing an extensible description for the product information, and the extension information may be usage information for the user to use the product. When the information-presentation-item is related to a notification item, the description information further includes detailed notification information related to the information-presentation-item. For example, when the information-presentation-item is an earthquake reminder notification, the notification information may include more detailed content of the earthquake notification, such as a predicted earthquake magnitude, a predicted latitude and longitude range of the earthquake, and recommended precautionary measures adopted by users, etc. The first extension information further includes extended information for providing an extensible description for the notification information. For example, the extension information may be geological conditions and historical earthquake record of the earthquake region, etc.

Generally, the extension information in the first extension information is richer and more vivid than the content of the description information. For example, when the information-presentation-item is an information-presentation-item related to a product, the extension information may be a photograph in which a user wears or uses the product, or a presentation video in which the product is being used.

The graphic code described herein may be a two-dimensional code, a bar code, or any other graphic code containing information recognition information. No specific limitation is intended herein.

Apparently, in an actual application, after receiving the confirmation instruction, the multimedia playback device may first perform step 302 and then perform step 303, or may first perform step 303 and then perform step 302, without any specific limitation on a particular sequence. In general, steps described in the embodiments do not need to be performed in any specific sequence, and each step may include one or more steps of actions to be performed by one or more actors.

Step 304: Displaying a pop-up overlay-floating-window with description information.

The description information may include a display graphic code, and the content of the description information is related to the content of the information-presentation-item. To enable the user to scan the graphic code in the description information by using a mobile device, the description information is usually displayed in a form of the overlay-floating-window.

Optionally, when the overlay-floating-window is popped up, the page displayed for the information-presentation-item is paused at the time point when the confirmation instruction is received.

When the pause information of the information-presentation-item is displayed, the description information is displayed by default, so as to enable the user to scan the graphic code in the description information, thereby enhancing interaction with the user, and improving pushing efficiency of the information-presentation-item.

Referring to FIG. 3C, FIG. 3C is a schematic diagram of an overlay-floating-window that displays description information according to an embodiment of the present invention. The overlay-floating-window displays the description information 32. The description information 32 includes a graphic code 32a and product information 32b. Apparently, the description information 32 further includes guidance information “Scan QR Code” for guiding the user to scan the graphic code 32a. The product information 32b includes a picture of a product, a discount, and the like.

In one implementation scenario, after the user scans, by using the mobile device, the graphic code in the description information displayed on the multimedia playback device, the mobile device generates a graphic code link. The graphic code link uniquely corresponds to the graphic code displayed on the multimedia playback device. That is, different graphic code links are generated when different mobile devices scan a same graphic code, or different graphic code links are generated when a same information-presentation-item is displayed on different multimedia playback devices and, apparently, graphic code links obtained after the mobile device performs scanning are also different. Further, the mobile device may send the graphic code link to the server, and the server notifies the multimedia playback device. A specific implementation may be illustrated in step 305a and step 306a, and another possible implementation in step 305b and step 306b.

Step 305a: Receiving a first scanning completion notification that is sent by the server to indicate that the graphic code is scanned.

The first scanning completion notification is pushed by the server to the multimedia playback device after the server receives the graphic code link sent by the mobile device, where the graphic code link is a unique graphic code link generated by the mobile device after scanning the graphic code. In certain embodiments, the graphic code link may be a webpage locator, such as a universal resource locator (URL), and the multimedia playback device may be unable to process such webpage address (for example, when the multimedia playback device does not include a browser software).

Step 306a: Confirming that the graphic code in the description information is scanned after the first scanning completion notification is received.

That is, for the multimedia playback device to receive the scanning completion notification from the server, the graphic code displayed on the multimedia playback device is provided by the server, and the server can determine the scanned graphic code according to the graphic code link sent by the mobile device.

Optionally, in an actual application, the graphic code may be generated by the multimedia playback device in real time and added to the description information. For a same information-presentation-item, graphic codes generated by different multimedia playback devices are different. That is, when the multimedia playback device is to obtain a graphic code in the description information, the multimedia playback device may generate the graphic code in real time, and adds the graphic code to the description information. In this case, the generated graphic code uniquely corresponds to the multimedia playback device, and for the information-presentation-item, graphic codes generated by one multimedia playback device at different time points are also different. In this case, the manner in which the multimedia playback device determines whether scanning of the display graphic code is complete is not limited to the manner provided by step 305a and step 306a, and may include, for example, the following step 305b and step 306b.

Step 305b: Receiving a second scanning completion notification that is sent by the mobile device bound to the multimedia playback device and that indicates a scanned graphic code.

The second scanning completion notification is generated by the mobile device after the mobile device scans the graphic code and is sent to the multimedia playback device by using a connection established between the mobile device and the multimedia playback device. The second scanning completion notification carries an identifier used for uniquely identifying the graphic code.

Step 306b: Confirming that the graphic code in the description information is scanned after the second scanning completion notification is received.

For example, the multimedia playback device may be bound to a mobile device held by a user, and the multimedia playback device may establish a connection to the mobile device. After the user scans, by using the mobile device, a graphic code displayed on the multimedia playback device, the mobile device generates a second scanning completion notification, and sends the second scanning completion notification to the multimedia playback device. In this way, the multimedia playback device may directly receive, from the mobile device, the second scanning completion notification indicating that the graphic code is scanned. This manner is not affected by any network factor between the server and the multimedia playback device. Therefore, the multimedia playback device can respond to, at a significantly high speed, scanning of the graphic code by the mobile device.

Step 307: Displaying first extension information related to the information-presentation-item.

That is, after determining that the graphic code in the description information is scanned, the multimedia playback device displays the first extension information related to the information-presentation-item. For example, the multimedia playback device displays the first extension information in the overlay-floating-window, or replaces the description information with the first extension information in the overlay-floating-window, or displays the first extension information in another display location or region. This disclosure does not limit a specific manner of displaying the first extension information.

Generally, the first extension information is extension information of the description information, and content of the first extension information usually includes a part of the content of the description information, or the first extension information may include additional content corresponding to the description information. In one embodiment, the first extension information may include information used for indicating that the graphic code is successfully scanned.

FIG. 3D is a schematic diagram of replacing description information with first extension information in an overlay-floating-window according to an embodiment of the present invention. Referring to FIG. 3D, in the overlay-floating-window, the displayed description information 32 is replaced with first extension information 33 for displaying.

Thus, according to the information-presentation-item display method provided in the embodiments of the present invention, during playing of an information-presentation-item, description information related to the information-presentation-item is displayed under the control of a remote-control device, and a user may scan a graphic code according to the description information, to obtain more information. During playing of the information-presentation-item, the user can decide whether or not to be involved in or not involved in playing of the information-presentation-item or to scan the graphic code. Therefore, the following problems in related technologies can be resolved: during the playing process, the information-presentation-item is just played passively, and the information obtained by a user from the information-presentation-item is rather limited, making it less effective to push the information-presentation-item. In this way, during playing of an information-presentation-item, interaction between a multimedia playback device and a user is enhanced, and the effectiveness of pushing the information-presentation-item is improved.

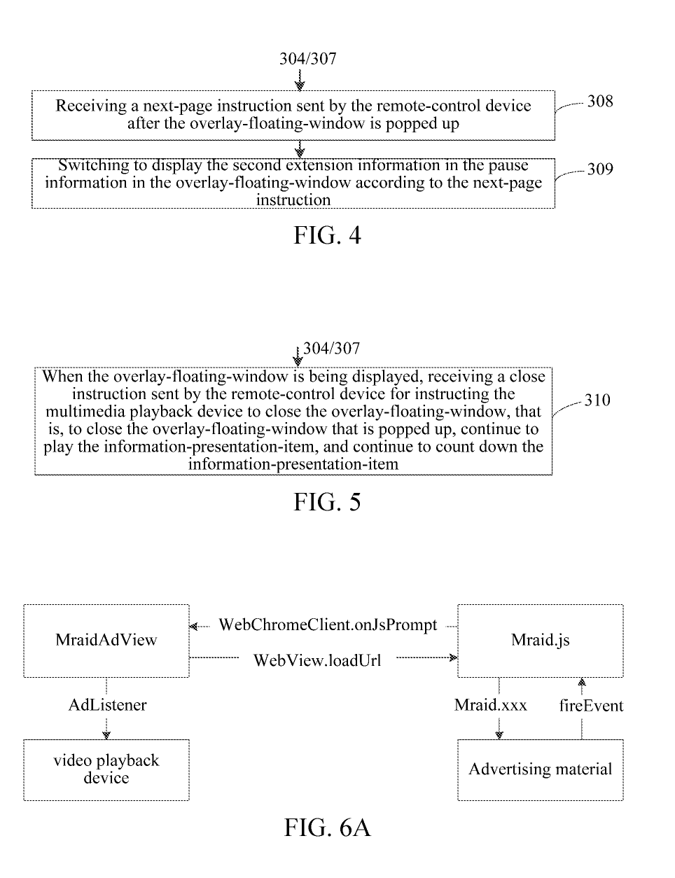

In an actual application, to provide more information related to the information-presentation-item, the pause information related to the information-presentation-item may further include at least second extension information, and each item of the second extension information in the pause information may correspond to one presentation page in the overlay-floating-window. FIG. 4 is a flowchart of an information-presentation-item display method according to still another embodiment of the present invention. Referring to FIG. 4, after step 304 or step 307, the information-presentation-item display method may further include the followings.

Step 308: Receiving a next-page instruction sent by the remote-control device after the overlay-floating-window is popped up.

The next-page instruction is generated after a preset next-page key on the remote-control device is triggered. The preset next-page key may be a volume down key, a volume up key, or any other key such as a channel up key or a channel down key, or may be a dedicated next-page key on the remote-control device. This embodiment does not limit the preset next-page key. However, it should be noted that generally, a key for generating the next-page instruction is different from a key for generating the confirmation instruction.

In an actual application, after the overlay-floating-window is popped up, the next-page instruction sent by the remote-control device may be received when the graphic code in the description information displayed in the overlay-floating-window is not scanned, or the next-page instruction sent by the remote-control device may be received after the graphic code in the description information displayed in the overlay-floating-window is scanned.

Step 309: Switching to display the second extension information in the pause information in the overlay-floating-window according to the next-page instruction.

After the overlay-floating-window is popped up and when the graphic code in the description information displayed in the overlay-floating-window is not scanned, the multimedia playback device switches, after receiving the next-page instruction, the displayed description information to the second extension information in the pause information for displaying in the overlay-floating-window. After the overlay-floating-window is popped up and after the graphic code in the description information displayed in the overlay-floating-window is scanned, the multimedia playback device switches, after receiving the next-page instruction, the displayed first extension information to the second extension information in the pause information for displaying in the overlay-floating-window.

To remind the user that more extension information can be pulled, a pulling control, for example, a pulling control 34 in FIG. 3C, may be displayed in the overlay-floating-window.

Optionally, indicator elements in a one-to-one correspondence with extension information may be displayed in the overlay-floating-window. The indicator elements may be used as an indicator element group, and each indicator element corresponds to one piece of extension information. When a piece of extension information is currently presented in the overlay-floating-window, an indicator element corresponding to the extension information is distinctively displayed, for example, is highlighted. Still referring to FIG. 3C, an indicator element 35a in an indicator element group 35 is distinctively displayed.

In an implementation scenario, when a user no longer wants to view the pause information of the information-presentation-item, the user may choose to close the overlay-floating-window, which may specifically refer to FIG. 5.

Referring to FIG. 5, FIG. 5 is a flowchart of an information-presentation-item display method according to another embodiment of the present invention. After step 304 or step 307, the information-presentation-item display method may further include the followings.

Step 310: When the overlay-floating-window is being displayed, receiving a close instruction sent by the remote-control device for instructing the multimedia playback device to close the overlay-floating-window, that is, to close the overlay-floating-window that is popped up, continue to play the information-presentation-item, and continue to count down the information-presentation-item.

Similarly, the close instruction herein is generated after a preset close key on the remote-control device is pressed. The preset close key may be any key on the remote-control device. The preset close key is generally different from the key for the next-page instruction.

After the multimedia playback device receives the close instruction, it determines that the user wants to close the overlay-floating-window. In this case, the displayed overlay-floating-window is closed, and the information-presentation-item continues to be played.

Optionally, when the information-presentation-item has a preset play-time duration, after step 302 of pausing a countdown for the information-presentation-item, the information-presentation-item may continue the countdown.

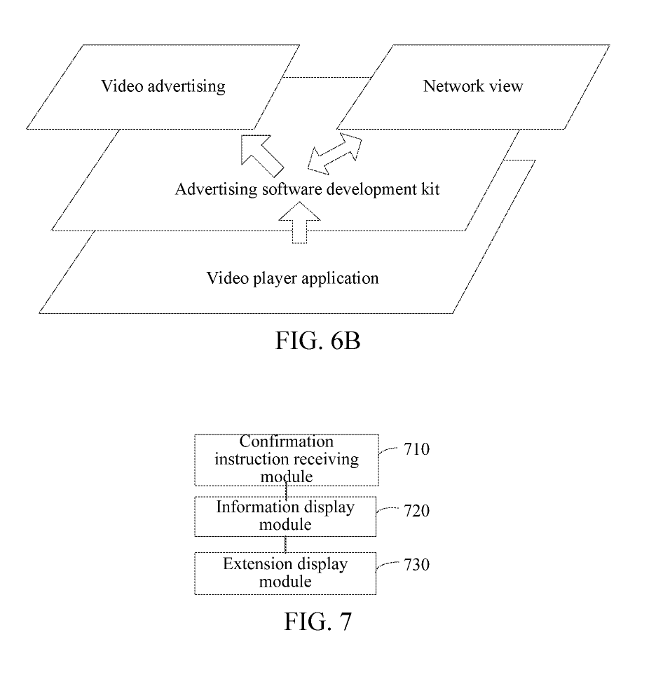

The foregoing embodiments may be implemented by using a rich media framework for mobile advertising software development kit (SDK). The rich media framework for the mobile advertising SDK is implemented by using native frameworks and a set of JavaScript interfaces developed based on the IAB (Interactive Advertising Bureau) Standard Mobile Rich Media Ad Interface Definitions (MRAID) protocol. In addition to the interfaces standardized by the protocol, characteristics of the information-presentation-item are extended, to make interaction between a rich media page and a multimedia player application more convenient, faster, and more efficient. The following describes the rich media framework for the mobile advertising SDK with reference to FIG. 6A and FIG. 6B.

With reference to FIG. 6A, for an information-presentation-item, a network view WebView is embedded in a rich media framework when the information-presentation-item is played. As shown in FIG. 6A, in WebView, a Mraid.js file is loaded by default to provide a rich media framework interface for a multimedia material. The Mraid.js file converts a request of the material into a character string j son, and performs communication by using interfaces provided by system calls prompt and MraidAdView of javascript for Android. MraidAdView sends the request obtained by means of parsing to a corresponding handler for processing. An interface (for example, pause or resume) related to video playing invokes an interface provided on a player side to perform processing, converts a returned value into a j son string, and returns the j son string to an advertising material.

This implementation can effectively avoid a security breach caused by an addjavascriptinterface format in the conventional Android system, and provide a secure mechanism to enable rich media code to interact with native code in an application, having stronger functions and better performance. In operation, with reference to FIG. 6B, after a user installs and opens a video player application on a video playback device (that is, a multimedia playback device that can play a video), and selects and watches a video, the video player application loads an advertising SDK to obtain advertisement-related data, and plays an information-presentation-item. If the information-presentation-item is an advertisement of a rich media type, a corresponding Webview page is loaded, and a rich media parameter is transferred to Webview. Webview renders different rich median information (such as a picture, text, or a two-dimensional code), that is, presents description information and various extension information such as first extension information and second extension information, according to content of the parameter.

A specific transaction process includes: after the Webview page is loaded by the video player application, it is first determined according to the MRAID protocol whether the Webview page has established an interaction protocol with the advertising SDK. If the protocol has been successfully established, it indicates that Webview can exchange data with the native video player application according to the protocol. In this case, a required rich media parameter (that is, pause information of an information-presentation-item) can be obtained from the advertising SDK. After the rich media parameter is obtained, template data that the rich media framework can recognize is established. The framework generates a final advertisement pattern (that is, an overlay-floating-window) according to the template data.

After the advertisement pattern is generated, the framework starts to add various events according to the template data. When it is detected that a graphic code needs to be requested, various events for the graphic code are registered. First, a multimedia playback device requests the graphic code from the server, and simultaneously establishes a socket; and connects to the socket after successfully obtaining the graphic code. After the user scans the graphic code by using a mobile device, the mobile device sends a graphic code link to the server. The server pushes a socket message to the multimedia playback device, to notify the multimedia playback device that the graphic code has been successfully scanned. Finally, js reports data, and displays scanning success information to the user according to first extension information.

It should also be noted that a case in FIG. 3C and FIG. 3D in which words are covered is presentation of an interaction interface configuration. When description information and first extension information or second extension information are displayed, all or a part of content of the information-presentation-item may be covered. Presentation in FIG. 3C and FIG. 3D is merely an example, and the displayed content and the display manner are not intended to limit the protection scope of the present disclosure.

All of the English documents involved in FIG. 6A and FIG. 6B are files frequently used in the programming field, and are usually not be expressed in Chinese. Therefore, the naming of the English documents involved in FIG. 6A and FIG. 6B is not intended to limit the protection scope of the present disclosure.

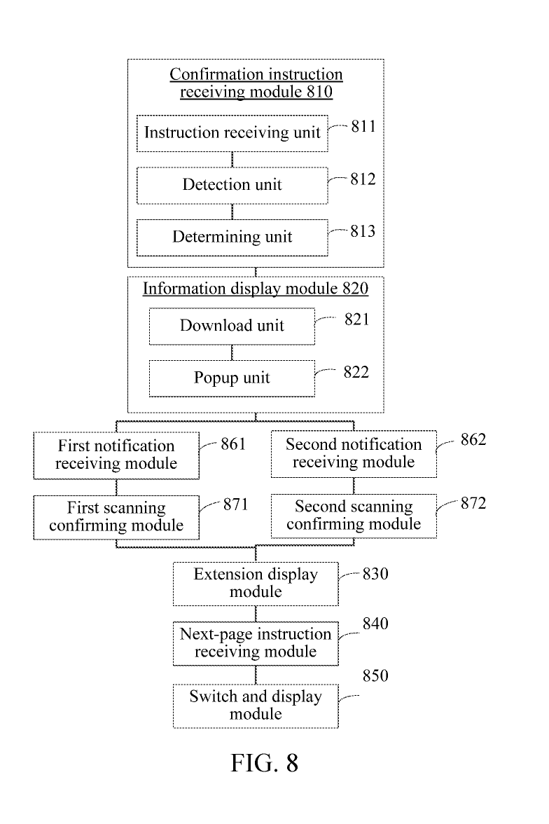

Referring to FIG. 7, FIG. 7 is a schematic structural diagram of an apparatus for displaying an information-presentation-item according to an embodiment of the present invention. As an example, the information-presentation-item display apparatus is applied to the multimedia playback device 120 in the implementation environment shown in FIG. 1. The apparatus for displaying the information-presentation-item may include a confirmation instruction receiving module 710, an information display module 720, and an extension display module 730.

The confirmation instruction receiving module 710 is configured to: during playing of an information-presentation-item, receive a confirmation instruction that is sent by a remote-control device bound to the multimedia playback device.

The information display module 720 is configured to display, according to the confirmation instruction received by the confirmation instruction receiving module 710, description information related to the information-presentation-item, the description information including a display graphic code.

The extension display module 730 is configured to display first extension information related to the information-presentation-item after it is confirmed that the graphic code is scanned, the first extension information being information for extending content in the description information.

Thus, according to the information-presentation-item display apparatus provided in this embodiment of the present invention, during playing of an information-presentation-item, description information related to the information-presentation-item is displayed under the control of a remote-control device, and a user may scan a graphic code according to the description information, to obtain more information. During playing of the information-presentation-item, the user can decide whether or not to be involved in or not involved in playing of the information-presentation-item or to scan the graphic code. Therefore, the following problems in related technologies can be resolved: during the playing process, the information-presentation-item is just played passively, and the information obtained by a user from the information-presentation-item is rather limited, making it less effective to push the information-presentation-item. In this way, during playing of an information-presentation-item, interaction between a multimedia playback device and a user is enhanced, and the effectiveness of pushing the information-presentation-item is improved.

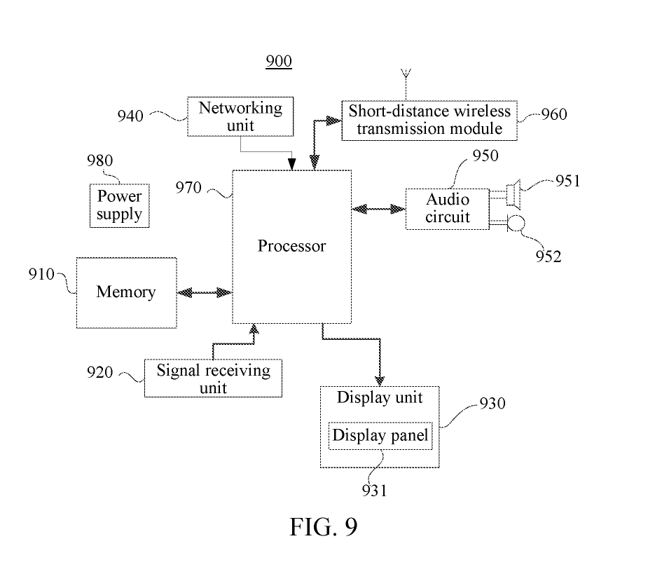

Referring to FIG. 8, FIG. 8 is a schematic structural diagram of an information-presentation-item display apparatus according to another embodiment of the present invention. As an example for description, the information-presentation-item display apparatus is applied to the multimedia playback device 120 in the implementation environment shown in FIG. 1. The information-presentation-item display apparatus may include a confirmation instruction receiving module 810, an information display module 820, and an extension display module 830.

The confirmation instruction receiving module 810 is configured to: during playing of an information-presentation-item, receive a confirmation instruction that is sent by a remote-control device bound to the multimedia playback device.

The information display module 820 is configured to display, according to the confirmation instruction received by the confirmation instruction receiving module 810, description information related to the information-presentation-item, the description information including a display graphic code.

The extension display module 830 is configured to display first extension information related to the information-presentation-item after it is confirmed that the graphic code is scanned, the first extension information being information for extending content in the description information.

In an implementation, the information display module 820 may further include a download unit 821 and a popup unit 822.

The download unit 821 is configured to: download, from a server, a set of pause information related to the information-presentation-item, the pause information including at least the description information and the first extension information.

The popup unit 822 is configured to pop up an overlay-floating-window displaying the description information.

In an implementation, the pause information further includes at least one piece of second extension information, and the information-presentation-item display apparatus further includes a next-page instruction receiving module 840 and a switch and display module 850.

The next-page instruction receiving module 840 is configured to receive a next-page instruction sent by the remote-control device after the popup unit pops up the overlay-floating-window.

The switch and display module 850 is configured to switch to display the second extension information in the pause information in the overlay-floating-window according to the next-page instruction received by the next-page instruction receiving module 840.

In an implementation, the confirmation instruction receiving module 810 may include an instruction receiving unit 811, a detection unit 812, and a determining unit 813.

The instruction receiving unit 811 is configured to receive an instruction that is sent by the remote-control device bound to the multimedia playback device.

The detection unit 812 is configured to detect whether the instruction is the same as a prestored instruction, the prestored instruction being an instruction that is prestored by the multimedia playback device and that is the same as an instruction generated by the remote-control device in a preset manner.

The determining unit 813 is configured to determine that the confirmation instruction is received when the detection unit 812 detects that the instruction is the same as the prestored instruction.

In an implementation, the information-presentation-item display apparatus may further include a first notification receiving module 861 and a first scanning confirming module 871.

The first notification receiving module 861 is configured to: receive a first scanning completion notification that is sent by the server and that indicates the scanned graphic code, the first scanning completion notification being pushed by the server to the multimedia playback device after the server receives a graphic code link sent by a mobile device, and the graphic code link being a unique graphic code link generated by the mobile device after scanning the graphic code.

The first scanning confirming module 871 is configured to confirm that the graphic code is scanned after the first notification receiving module 861 receives the first scanning completion notification.

In an implementation, the information-presentation-item display apparatus may further include a second notification receiving module 862 and a second scanning confirming module 872.

The second notification receiving module 862 is configured to receive a second scanning completion notification that is sent by a mobile device bound to the multimedia playback device and that indicates the scanned graphic code, the second scanning completion notification being generated by the mobile device after the mobile device scans the graphic code and being sent to the multimedia playback device by using a connection established between the mobile device and the multimedia playback device, and the second scanning completion notification carrying an identifier used for uniquely identifying the graphic code.

The second scanning confirming module 872 is configured to confirm that the graphic code is scanned after the second notification receiving module 862 receives the second scanning completion notification.

During implementation, the information-presentation-item display apparatus may include only the first notification receiving module 861 and the first scanning confirming module 871, or may include only the second notification receiving module 862 and the second scanning confirming module 872, or may simultaneously include the first notification receiving module 861, the first scanning confirming module 871, the second notification receiving module 862, and the second scanning confirming module 872.

In an implementation, the information-presentation-item displays guidance information used for guiding a user to control the remote-control device, and the confirmation instruction is generated after the user correspondingly controls the remote-control device according to the guidance information.

The description information further includes product information related to the information-presentation-item, and the first extension information further includes extension information for providing an extensible description for the product information.

Thus, according to the information-presentation-item display apparatus provided in the embodiments of the present invention, during playing of an information-presentation-item, description information related to the information-presentation-item is displayed under the control of a remote-control device, and a user may scan a graphic code according to the description information, to obtain more information. During playing of the information-presentation-item, the user can decide whether or not to be involved in or not involved in playing of the information-presentation-item or to scan the graphic code. Therefore, the following problems in related technologies can be resolved: during the playing process, the information-presentation-item is just played passively, and the information obtained by a user from the information-presentation-item is rather limited, making it less effective to push the information-presentation-item. In this way, during playing of an information-presentation-item, interaction between a multimedia playback device and a user is enhanced, and the effectiveness of pushing the information-presentation-item is improved.

It should be noted that when the information-presentation-item display apparatus provided in the foregoing embodiments presents an information-presentation-item, division of the functional modules is only used as an example for description. In an actual application, the functions may be allocated to different functional modules according to specific needs, which means that the internal structure of the multimedia playback device is divided into different functional modules to complete all or some of the above described functions. In addition, the information-presentation-item display apparatus and the information-presentation-item display method provided in the foregoing embodiments have a same concept. For a specific implementation process of the apparatus, it may refer to the method embodiments, details of which are not repeated herein.

FIG. 9 is a schematic structural diagram of a multimedia playback device according to an embodiment of the present invention. The multimedia playback device 900 may be implemented as a smart TV, a combination of a smart TV and a set top box, or a smart TV integrating a function of a set top box.

The multimedia playback device 900 may include parts such as a memory 910 including one or more computer readable storage media, a signal receiving unit 920, a display unit 930, a networking unit 940, an audio circuit 950, a short-distance wireless transmission module 960, a processor 970 including one or more processing cores, and a power supply 980. A person skilled in the art may understand that the structure of the multimedia playback device shown in FIG. 9 does not constitute any limitation to the multimedia playback device. The multimedia playback device may include more or fewer parts than those shown in the figure, may combine some parts, or may have different part arrangements.

The memory 910 may be configured to store a software program and module. For example, the memory 910 may be configured to store a software program for playing a video, a software program for a countdown, and a software program for recognizing information sent by a server or a mobile device, and may be further configured to store a binding relationship between the multimedia playback device and the mobile device, a prestored instruction related to a remote-control device, a preset decoding instruction for decoding a signal transmitted by the remote-control device, and the like.

The processor 970 executes various function applications and performs data processing by running the software program and module stored in the memory 910. The memory 910 may mainly include a program storage area and a data storage area. The program storage area may store an operating system, an application required by at least one function (such as a video playing function, an image display function, and a touchscreen recognition function), and the like. The data storage area may store data created according to use of the multimedia playback device 900, and the like. In addition, the memory 910 may include a high speed random access memory, and may also include a non-volatile memory such as at least one magnetic disk storage device, a flash memory, or another volatile solid-state storage device. Correspondingly, the memory 910 may further include a memory controller, to provide access of the processor 970 and the signal receiving unit 920 to the memory 910.

The signal receiving unit 920 may be configured to receive a signal transmitted by the remote-control device. Specifically, after receiving the signal transmitted by the remote-control device, the signal receiving unit 920 sends the signal to the processor 970, and the processor 970 decodes the signal in a preset decoding manner stored by the memory.

The display unit 930 may be configured to display an obtained video stream, displayed information obtained from the server, and the like. The display unit 930 may include a display panel 931. Optionally, the display panel 931 may be configured in a form of a liquid crystal display (LCD), an organic light-emitting diode (OLED), or the like.

The networking unit 940 may be networked with the server, to obtain a related video stream or other information from the server. The audio circuit 950, a speaker 951, and a microphone 952 can provide an audio interface between a user and the multimedia playback device 900. The audio circuit 950 may transmit, to the speaker 951, an electrical signal that is obtained after received audio data is converted, and the speaker 951 converts the electrical signal into a sound signal for output. In another aspect, the microphone 952 converts a collected sound signal into an electrical signal, the audio circuit 950 receives the electrical signal, converts it into audio data, and then outputs the audio data to the processor 970 for processing, and then the audio data is output to the memory 910 for further processing. The audio circuit 950 may further include a headset jack to provide communication between a peripheral headset and the multimedia playback device 900.

The short-distance wireless transmission module 960 may be a wireless fidelity (WiFi) module, a Bluetooth module, or the like. The multimedia playback device 900 may help, by using the short-distance wireless transmission module 960, the user to send and receive an email, browse a web page, access streaming media, and the like. The multimedia playback device 900 provides wireless broadband Internet access for the user. Although FIG. 9 shows the short-distance wireless transmission module 960, it may be understood that the short-distance wireless transmission module 960 is not a necessary part of the multimedia playback device 900, and when required, the short-distance wireless transmission module 960 may be omitted without changing the scope of the essence of the present disclosure.

The processor 970 is a control center of the multimedia playback device 900, and is connected to various parts of the entire mobile multimedia playback device by using various interfaces and lines. By running or executing the software program and/or module stored in the memory 910, and invoking data stored in the memory 910, the processor 970 performs various functions and data processing of the multimedia playback device 900, thereby overall monitoring the mobile multimedia playback device. Optionally, the processor 970 may include one or more processing cores. Optionally, the processor 970 may integrate an application processor and a modem. The application processor mainly processes an operating system, a user interface, an application, and the like. The modem mainly processes wireless communication. It may be understood that the foregoing modem may not be integrated into the processor 970.

The multimedia playback device 900 further includes the power supply 980 (for example, a battery) that supplies power to each part. Preferably, the power supply may be logically connected to the processor 970 by using a power supply management system, so that functions such as management of charging, discharging, and power consumption are implemented by using the power supply management system. The power supply 980 may further include any component, such as one or more direct current power supplies or alternating current power supplies, a recharging system, a power supply fault detection circuit, a power converter or a power inverter, or a power status indicator.

Although not shown, the multimedia playback device 900 may further include a camera, a Bluetooth module, a universal serial bus (English: Universal Serial Bus, USB) port, a video signal interface VGA, DVI, or HDMI connected to the set top box, and the like. Details are not described herein. In the embodiments of this application, the set top box and the smart TV are integrated to serve as the multimedia playback device in this application.

One or more programs stored in the memory 910 are configured to be executed by one or more processors. The one or more programs include instructions used for performing the following operations: during playing of an information-presentation-item, receiving a confirmation instruction that is sent by a remote-control device bound to the multimedia playback device; displaying, according to the confirmation instruction, description information related to the information-presentation-item, the description information including a display graphic code; and displaying first extension information related to the information-presentation-item after it is confirmed that the graphic code is scanned, the first extension information being information for extending content in the description information.

Optionally, the one or more programs further include instructions used for performing the following operations: downloading, from a server, a set of pause information related to the information-presentation-item, the pause information including at least the description information; and popping up an overlay-floating-window displaying the description information.

Optionally, the one or more programs further include instructions used for performing the following operations: receiving a next-page instruction sent by the remote-control device; and switching to display the second extension information in the pause information in the overlay-floating-window according to the next-page instruction.

Optionally, the one or more programs further include instructions used for performing the following operations: receiving an instruction that is sent by the remote-control device bound to the multimedia playback device; detecting whether the instruction is the same as a prestored instruction, the prestored instruction being an instruction that is prestored by the multimedia playback device and that is the same as an instruction generated by the remote-control device in a preset manner; and determining that the confirmation instruction is received if the instruction is the same as the prestored instruction.

Optionally, the one or more programs further include instructions used for performing the following operations: receiving a first scanning completion notification that is sent by the server and that indicates the scanned graphic code, the first scanning completion notification being pushed by the server to the multimedia playback device after the server receives a graphic code link sent by a mobile device, and the graphic code link being a unique graphic code link generated by the mobile device after scanning the graphic code; and confirming that the graphic code is scanned after the first scanning completion notification is received.

Optionally, the one or more programs further include instructions used for performing the following operations: receiving a second scanning completion notification that is sent by a mobile device bound to the multimedia playback device and that indicates the scanned graphic code, the second scanning completion notification being generated by the mobile device after the mobile device scans the graphic code and being sent to the multimedia playback device by using a connection established between the mobile device and the multimedia playback device, and the second scanning completion notification carrying an identifier used for uniquely identifying the graphic code; and confirming that the graphic code is scanned after the second scanning completion notification is received.

Optionally, the information-presentation-item displays guidance information used for guiding a user to control the remote-control device, the confirmation instruction is generated after the user correspondingly controls the remote-control device according to the guidance information, the description information further includes product information related to the information-presentation-item, and the first extension information further includes extension information for providing an extensible description for the product information.

A person of ordinary skill in the art may understand that all or some of the steps of the foregoing embodiments may be implemented by using hardware, or may be implemented by a program instructing relevant hardware. The program may be stored in a computer readable storage medium. The storage medium may be a read-only memory, a magnetic disk, an optical disc, or the like.

The foregoing descriptions are merely preferred embodiments of the present invention, but are not intended to limit the present disclosure. Any modification, equivalent replacement, or improvement made within the spirit and principle of the present disclosure shall fall within the protection scope of the present disclosure.

What is claimed is:

1. An information-presentation-item display method implemented by a multimedia playback device connected to a server, the method comprising:
playing a first content;
playing an information-presentation-item, different from the first content, provided by the server;
receiving a confirmation instruction sent by a remote-control device bound to the multimedia playback device;
displaying, according to the confirmation instruction, description information related to the information-presentation-item, the description information including a display graphic code; and
displaying first extension information related to the information-presentation-item after it is confirmed that the graphic code is scanned based on a graphic code link corresponding to the graphic code received by the server, the first extension information being information for extending content in the description information.

2. The method according to claim 1, wherein the displaying, according to the confirmation instruction, description information related to the information-presentation-item comprises:
downloading, from the server, a set of pause information related to the information-presentation-item, the pause information including at least the description information; and
popping up an overlay-floating-window displaying the description information.

3. The method according to claim 2, wherein the pause information further includes at least one piece of second extension information, and the method further comprises:
receiving a next-page instruction sent by the remote-control device; and
switching to display the second extension information in the pause information in the overlay-floating-window according to the next-page instruction.

4. The method according to claim 1, wherein the receiving a confirmation instruction sent by a remote-control device bound to the multimedia playback device comprises:
receiving an instruction sent by the remote-control device bound to the multimedia playback device;
detecting whether the instruction is the same as a prestored instruction, the prestored instruction being prestored by the multimedia playback device; and
determining that the confirmation instruction is received if the instruction is the same as the prestored instruction.

5. The method according to claim 1, further comprising:
receiving a first scanning completion notification sent by the server for indicating the scanned graphic code, the first scanning completion notification being pushed by the server to the multimedia playback device after the server receives the graphic code link, wherein the graphic code link is a unique graphic code link generated by a mobile device after scanning the graphic code; and
confirming that the graphic code is scanned after the first scanning completion notification is received.

6. The method according to claim 1, wherein the information-presentation-item displays guidance information used for guiding a user to control the remote-control device, and the confirmation instruction is generated after the user correspondingly controls the remote-control device according to the guidance information; and
the description information further comprises product information related to the information-presentation-item, and the first extension information further comprises extension information for providing an extensible description for the product information.

7. A non-transitory computer-readable storage medium containing computer-executable instructions for, when executed by one or more processors, performing an information-presentation-item display method for a multimedia playback device connected to a server, the method comprising:
playing a first content;
playing an information-presentation-item, different from the first content, provided by the server;
receiving a confirmation instruction sent by a remote-control device bound to the multimedia playback device;
displaying, according to the confirmation instruction, description information related to the information-presentation-item, the description information including a display graphic code; and
displaying first extension information related to the information-presentation-item after it is confirmed that the graphic code is scanned based on a graphic code link corresponding to the graphic code received by the server, the first extension information being information for extending content in the description information.

8. The non-transitory computer-readable storage medium according to claim 7, wherein the displaying, according to the confirmation instruction, description information related to the information-presentation-item comprises:
downloading, from the server, a set of pause information related to the information-presentation-item, the pause information including at least the description information; and
popping up an overlay-floating-window displaying the description information.

9. The non-transitory computer-readable storage medium according to claim 8, wherein the pause information further includes at least one piece of second extension information, and the method further comprises:
receiving a next-page instruction sent by the remote-control device; and
switching to display the second extension information in the pause information in the overlay-floating-window according to the next-page instruction.

10. The non-transitory computer-readable storage medium according to claim 7, wherein the receiving a confirmation instruction sent by a remote-control device bound to the multimedia playback device comprises:
receiving an instruction sent by the remote-control device bound to the multimedia playback device;
detecting whether the instruction is the same as a prestored instruction, the prestored instruction being prestored by the multimedia playback device; and
determining that the confirmation instruction is received if the instruction is the same as the prestored instruction.

11. The non-transitory computer-readable storage medium according to claim 7, wherein the method further comprises:
receiving a first scanning completion notification sent by the server for indicating the scanned graphic code, the first scanning completion notification being pushed by the server to the multimedia playback device after the server receives the graphic code link, wherein the graphic code link is a unique graphic code link generated by a mobile device after scanning the graphic code; and
confirming that the graphic code is scanned after the first scanning completion notification is received.

12. The non-transitory computer-readable storage medium according to claim 7, wherein the information-presentation-item displays guidance information used for guiding a user to control the remote-control device, and the confirmation instruction is generated after the user correspondingly controls the remote-control device according to the guidance information; and
the description information further comprises product information related to the information-presentation-item, and the first extension information further comprises extension information for providing an extensible description for the product information.

13. A multimedia playback device connected to a server, the multimedia playback device comprising:
a memory storing one or more programs; and
one or more processors coupled to the memory and, when executing the one or more programs, configured for:
playing a first content;
playing an information-presentation-item, different from the first content, provided by the server;
receiving a confirmation instruction sent by a remote-control device bound to the multimedia playback device;
displaying, according to the confirmation instruction, description information related to the information-presentation-item, the description information including a display graphic code; and
displaying first extension information related to the information-presentation-item after it is confirmed that the graphic code is scanned based on a graphic code link corresponding to the graphic code received by the server, the first extension information being information for extending content in the description information.

14. The multimedia playback device according to claim 13, wherein the displaying, according to the confirmation instruction, description information related to the information-presentation-item comprises:
downloading, from the server, a set of pause information related to the information-presentation-item, the pause information including at least the description information; and
popping up an overlay-floating-window displaying the description information.

15. The multimedia playback device according to claim 14, wherein the pause information further includes at least one piece of second extension information, and the processors are further configured for:
receiving a next-page instruction sent by the remote-control device; and
switching to display the second extension information in the pause information in the overlay-floating-window according to the next-page instruction.

16. The multimedia playback device according to claim 13, wherein the receiving a confirmation instruction sent by a remote-control device bound to the multimedia playback device comprises:
receiving an instruction sent by the remote-control device bound to the multimedia playback device;
detecting whether the instruction is the same as a prestored instruction, the prestored instruction being prestored by the multimedia playback device; and
determining that the confirmation instruction is received if the instruction is the same as the prestored instruction.

17. The multimedia playback device according to claim 13, wherein the processors are further configured for:
receiving a first scanning completion notification sent by the server for indicating the scanned graphic code, the first scanning completion notification being pushed by the server to the multimedia playback device after the server receives the graphic code link, wherein the graphic code link is a unique graphic code link generated by a mobile device after scanning the graphic code; and
confirming that the graphic code is scanned after the first scanning completion notification is received.

18. The multimedia playback device according to claim 13, wherein the information-presentation-item displays guidance information used for guiding a user to control the remote-control device, and the confirmation instruction is generated after the user correspondingly controls the remote-control device according to the guidance information; and
the description information further comprises product information related to the information-presentation-item, and the first extension information further comprises extension information for providing an extensible description for the product information.
